(19) United States
(12) Patent Application Publication
(10) Pub. No.: US 2026/0307547 A1
(43) Pub. Date: Oct. 8, 2026

(54) VEHICLE SEAT VIBRATION SUPPRESSION DEVICE AND METHOD

(71) Applicants: Hyundai Motor Company, Seoul (KR); Kia Corporation, Seoul (KR); Dongguk University Industry-Academic Cooperation Foundation, Seoul (KR)

(72) Inventors: Seung Hyeon CHO, Hwaseong-Si (KR); Hyun Kyu PARK, Hwaseong-Si (KR); Yong Ha HAN, Hwaseong-Si (KR); Eun Sue KIM, Hwaseong-Si (KR); Youn Sic NAM, Hwaseong-Si (KR); Moon Kyu KWAK, Seoul (KR)

(21) Appl. No.: 19/405,584

(22) Filed: Dec. 2, 2025

(30) Foreign Application Priority Data
Apr. 8, 2025 (KR) 10-2025-0045681

(51) Int. Cl. B60N 2/02; B60N 2/10; B60N 2/16; B60N 2/50

(52) U.S. Cl. CPC B60N 2/0244; B60N 2/10; B60N 2/16; B60N 2/501; B60N 2/505

(57) ABSTRACT

A vehicle seat vibration suppression device includes a height adjusting actuator that adjusts the height of a seat, a counteracting force determination unit that receives an excitation frequency of the seat as an input and determines a counteracting force for suppressing vibration of the seat, and a displacement command generator that determines a control displacement of the height adjusting actuator for implementing the counteracting force determined by the counteracting force determination unit and provides the result to the height adjusting actuator. The vehicle seat vibration suppression device may operate a method to cancel/reduce seat vibrations.

### CROSS-REFERENCE TO THE RELATED APPLICATION

This application claims priority from Korean Patent Application No. 10-2025-0045681, filed on Apr. 8, 2025, in the Korean Intellectual Property Office, the disclosure of which is incorporated herein by reference in its entirety.

### TECHNICAL FIELD

The present disclosure relates to a technique capable of actively controlling a vehicle seat to improve ride comfort of an occupant.

### BACKGROUND

During driving, the body and seats of a vehicle vibrate due to interaction with a road surface, and an occupant may feel discomfort and fatigue due to such vibration.

Vehicle seats may be provided with an active vibration control function for adjusting a height and/or tilt of the seat. An actuator including a motor or the like may be provided to implement the function.

The above information disclosed in the background section is only for understanding of a technical background of the disclosure, and therefore, should not be interpreted to disclose the prior art that is already known to those skilled in the art.

### SUMMARY

The following summary presents a simplified summary of certain features. The summary is not an extensive overview and is not intended to identify key or critical elements.

Systems, apparatuses/devices, and methods are described for vehicle seat vibration suppression. A vehicle seat vibration suppression device may comprise: a height adjusting actuator configured to adjust a height of a seat of a vehicle; a controller circuit configured to: receive, from a filter of a plurality of filters of a signal processor, an excitation frequency of the seat; and determine, based on the excitation frequency, a counteracting force for suppressing vibration of the seat; and a displacement command generator configured to: determine, based on the counteracting force, a control displacement of the height adjusting actuator for implementing the counteracting force; and provide the control displacement to the height adjusting actuator to cause the height adjusting actuator to adjust the height of the seat of the vehicle.

Also, or alternatively, a vehicle seat vibration suppression method may comprise: receiving, by a controller circuit and from a signal processor, an excitation frequency of a seat of a vehicle; determining, based on the excitation frequency, a counteracting force for suppressing vibration of the seat; determining, based on the counteracting force and via a displacement command generator, a control displacement of a height adjusting actuator of the seat; and controlling, based on the control displacement, the height adjusting actuator to adjust a height of the seat to implement the counteracting force.

These and other features and advantages are described in greater detail below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram showing a configuration of a vehicle seat vibration suppression device according to an example of the present disclosure;

FIG. 2 is a diagram showing a model in which a mass of a seat is m, and a virtual mass of a control system for suppressing seat vibration is ma;

FIG. 3 is a diagram schematically showing the model shown FIG. 2;

FIG. 4 is a diagram showing a model of a road surface, a vehicle, and a seat;

FIG. 5 is a diagram illustrating the principle that seat vibration is canceled by operations of a height adjusting actuator and a tilt adjusting actuator according to an example of the present disclosure;

FIG. 6 is a flowchart illustrating a continuous control mode and an instantaneous control mode according to an example of the present disclosure; and

FIG. 7 is a flowchart illustrating an example of a vehicle seat vibration suppression method according to an example of the present disclosure.

### DETAILED DESCRIPTION

Reference will now be made in detail to examples of the present disclosure illustrated in the accompanying drawings. It should be understood that the accompanying drawings are given hereinafter by way of illustration only and are not limitative of the disclosure, and the present disclosure is intended to cover various alternatives, modifications, equivalents and other examples/implementations, within the spirit and scope of the disclosure as defined by the appended claims.

It will be understood that, although the terms “first”, “second”, etc. may be used herein to describe various elements, these elements should not be limited by these terms. These terms are only used to distinguish one element from another.

As used herein, the singular forms “a”, “an”, and “the” are intended to include the plural forms as well, unless the context clearly indicates otherwise.

It should be further understood that the terms “comprise”, “include”, and “have” used herein merely specify the presence of stated features, numbers, steps, operations, components, parts, or combinations thereof, but do not preclude the presence or addition of one or more other features, numbers, steps, operations, components, parts, or combinations thereof.

The expression “based on” as used herein is intended to describe one or more factors that influence an act or operation of determining or deciding described in a phrase or sentence including that expression, and this expression does not exclude any additional factors that influence the act or operation of determining or deciding.

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

Further, it will be understood that, if an element is “connected” or “coupled” to another element, the element may be directly connected or coupled to the other element, or may be indirectly connected or coupled to the other element with a different element interposed therebetween. In contrast, if an element is “directly connected” or “directly coupled” to another element, there is no intervening element therebetween.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. “One or more of” is synonymous with “at least one of” herein.

Throughout the present disclosure, references to units generally refer to items that logically can be grouped together to perform a function or group of related functions. Like reference numerals are generally intended to refer to the same or similar components. Units may be implemented in software, hardware or a combination of software and hardware. The units, and/or functions described above may be implemented and/or performed by one or more processors. For examples, the units may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The units may also include software control module(s) implemented with a processor or logic circuitry for example. The units may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

In addition, the terms “control unit” or “controller” is a widely used term for naming a controller that controls a specific vehicle function and does not refer to a generic functional unit. For example, each control unit may include a communication device that communicates with other control units or sensors, a memory that stores an operating system or logic instructions and input/output information, and one or more processors that perform necessary determinations, operations, and the like. The control unit/controller may include a memory storing an operation system, a logic command, and input/output information, and/or one or more processors performing determination, calculation, and decision necessary for controlling the function in charge. A control unit/controller may include, for example, a processor, a central processing unit (CPU), a microchip, a logic, an application-specific integrated circuit (ASIC), memory, etc. A control unit/controller may manipulate and/or control other components in the system (e.g., vehicle).

Any combination of the components disclosed herein may be included within the disclosure described herein. The components may include any combination of features described herein and may be arranged in various ways. Concepts concerning their uses and operations as well as structures and arrangements of the components may be applied to any example with any combination, as well as specific examples disclosed herein. Examples involving those having various features of various arrangements are described below with reference to the drawings.

Hereinafter, various examples of the present disclosure will be described with reference to the accompanying drawings. Wherever possible, the same reference numbers will be used throughout the drawings to refer to the same or like parts.

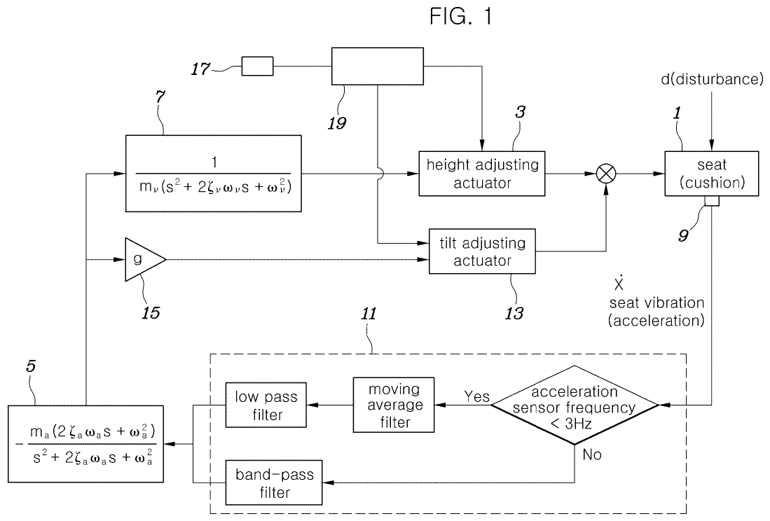

Referring to FIG. 1, a seat vibration suppression device according to an example of the present disclosure may include a height adjusting actuator 3 that adjusts the height of a seat 1, a counteracting force determination unit 5 (e.g., computing device, controller) that receives an excitation frequency of the seat as an input and determines a counteracting force for suppressing vibration of the seat, and a displacement command generator 7 that determines a control displacement of the height adjusting actuator 3 for implementing the counteracting force determined by the counteracting force determination unit 5 and provides the result to the height adjusting actuator 3.

The seat vibration suppression device according to the present example may determine the counteracting force for suppression (e.g., reducing/counteracting) the vibration of the seat using/based on the excitation frequency of the seat, determine the control displacement of the height adjusting actuator 3 for implementing the counteracting force, and control the height adjusting the actuator 3, thereby suppressing the vibration applied to the seat.

In an example, the vehicle seat vibration suppression device may further include an acceleration sensor 9 that may detect the vibration of the seat, and a signal processing unit 11 (e.g., signal processor, a signal filter) that may process an output signal from the acceleration sensor 9. the signal processing unit 11 may determine, based on the output signal, and/or output/send the excitation frequency of the seat to the counteracting force determination unit 5 (e.g., for input to the counteracting force determination unit 5).

The signal processing unit 11 may processes the output signal of the acceleration sensor 9 with/using different filters according to/based on whether the frequency of the output signal of the acceleration sensor 9 satisfies a frequency criteria (e.g., whether the frequency of the output signal is less than, or equal to or greater than a predetermined reference frequency, such as 3 Hz in FIG. 1, solely as an example). The signal processing unit 11 may process the output signal with/using a selected filter to determine the excitation frequency. The signal processing unit 11 may output the determined excitation frequency to the counteracting force determination unit 5).

The signal processing unit 11 may allow the output signal of the acceleration sensor 9 to sequentially pass through a moving average filter and a low pass filter in a case where the frequency of the output signal of the acceleration sensor 9 satisfies a frequency criteria (e.g., is less than the predetermined reference frequency). The signal processing unit 11 may allow the output signal of the acceleration sensor 9 to pass through a band-pass filter in a case where the frequency of the output signal of the acceleration sensor 9 does not satisfy the frequency criteria (e.g., is equal to or greater than the reference frequency). The signal processing unit 11 may output, from the low pass filter or the band-pass filter, the excitation frequency (e.g., a signal having/indicating the excitation frequency).

Here, the reference frequency may be determined/selected (as, for example, 3 Hz as illustrated in the example of the figures) by a number of experiments and analyses so that the excitation frequency of the seat can be accurately determined.

The counteracting force determination unit 5 may determine the counteracting force according to Equation 1.

$$\frac{F ( s )}{\ddot{X} ( s )} = - \frac{{m}_{a} ( 2 {ζ}_{α} {ω}_{α} s + {ω}_{α}^{2} )}{{s}^{2} + 2 {ζ}_{α} {ω}_{α} s + {ω}_{α}^{2}} \qquad [ Equation 1 ]$$

F(s): Laplace transform of counteracting force
\ddot{X}(s): Laplace transform of vibration (acceleration) of seat
mₐ: virtual mass of control system for suppressing seat vibration, which is a function of vehicle mass, seat mass, and tuning factor
ζ_{α}: damping ratio of control system
ωₐ: excitation frequency of seat
s: Laplace variable

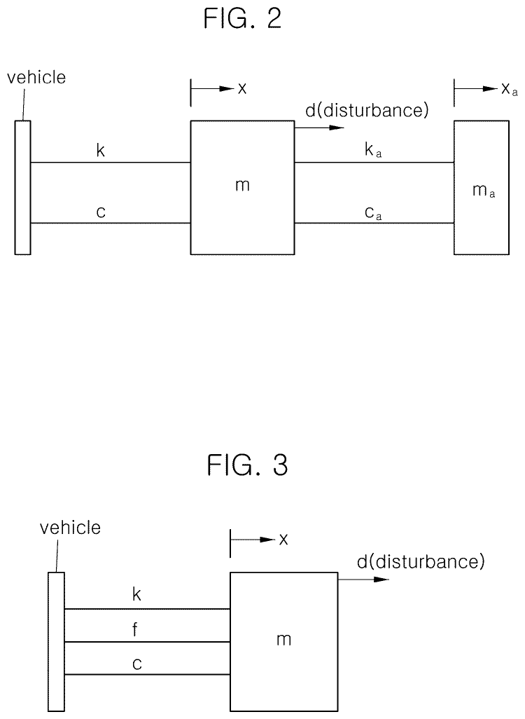

FIG. 2 shows an example model in which the mass of the seat is m and the virtual mass of the control system for suppression the seat vibration is mₐ, which may be expressed as the following motion equation.

$$m \ddot{x} + ( c + {c}_{a} ) \dot{x} - {c}_{a} {\dot{x}}_{a} + ( k + {k}_{a} ) x - {k}_{a} {x}_{a} = d \qquad [ Equation 2 ]$$

$${m}_{a} {\dot{x}}_{a} - {c}_{a} \dot{x} + {c}_{a} {\dot{x}}_{a} - {k}_{a} x + {k}_{a} {x}_{a} = 0 \qquad [ Equation 3 ]$$

m: seat mass
mₐ: virtual mass of the control system
c: damping coefficient of seat for vehicle
k: spring coefficient of seat for vehicle
cₐ: virtual damping coefficient of control system for seat
kₐ: virtual spring coefficient of control system for seat

If the counteracting force, which is a force due to the virtual mass mₐ of the control system, is depicted as f, the model of FIG. 2 may be expressed/illustrated as shown in FIG. 3. In this case, a motion equation of the mass m in FIG. 3 may be expressed as follows.

$$m \ddot{x} + c \dot{x} + kx = f + d \qquad [ Equation 4 ]$$

By substituting Equation 2 into Equation 4, Equation 5 may be obtained.

$$f = - {c}_{a} \dot{x} + {c}_{a} {\dot{x}}_{a} - {k}_{a} x + {k}_{a} {x}_{a} \qquad [ Equation 5 ]$$

By substituting Equation 5 into Equation 3, Equation 6 may be obtained.

$$f = - {m}_{a} {\ddot{x}}_{a} \qquad [ Equation 6 ]$$

By performing a Laplace transform on Equation 6, Equation 7 may be obtained.

$$F ( s ) = - {m}_{a} {s}^{2} {X}_{a} ( s ) \qquad [ Equation 7 ]$$

By performing a Laplace transform using Equations 2 and 3, Equation 8 may be obtained.

$$\frac{{X}_{a} ( s )}{X ( s )} = \frac{{c}_{a} s + {k}_{a}}{{m}_{a} {s}^{2} + {c}_{a} s + {k}_{a}} = \frac{2 {ξ}_{a} {ω}_{a} s + {ω}_{a}^{2}}{{s}^{2} + 2 {ξ}_{a} {ω}_{a} s + {ω}_{a}^{2}} \qquad [ Equation 8 ]$$

Using Equations 7 and 8, the above-mentioned Equation 1 may be obtained as follows.

$$\frac{{X}_{a} ( s )}{X ( s )} \times \frac{F ( s )}{{s}^{2} {X}_{a} ( s )} = \frac{F ( s )}{{s}^{2} X ( s )} = \frac{F ( s )}{\ddot{X} ( s )} = \frac{- {m}_{a} ( 2 {ξ}_{a} {ω}_{a} s + {ω}_{a}^{2} )}{{s}^{2} + 2 {ξ}_{a} {ω}_{a} s + {ω}_{a}^{2}}$$

Accordingly, by multiplying Equation 1 obtained as described above by X(s), which is the Laplace transform of the vibration (acceleration) of the seat, it is possible to obtain F(s) which is the Laplace transform of the counteracting force.

The displacement command generator 7 may determine the control displacement of the height adjusting actuator 3 by multiplying Equation 9 by the Laplace transform of the counteracting force (F(s)).

$$\frac{U ( s )}{F ( s )} = \frac{1}{{m}_{v} {s}^{2} + {c}_{v} s + {k}_{v}} = \frac{1}{{m}_{v} ( {s}^{2} + 2 {ξ}_{v} {ω}_{v} s + {w}_{v}^{2} )} \qquad [ Equation 9 ]$$

U(s): Laplace transform for control displacement of height adjusting actuator 3
F(s): Laplace transform of counteracting force
mᵥ: vehicle mass
cᵥ: vehicle suspension damping coefficient
kᵥ: vehicle suspension spring coefficient
ζᵥ: vehicle suspension damping ratio
ωᵥ: vehicle suspension natural frequency

Equation 9 may be derived by performing a Laplace transform of Equation 10.

$$f = {m}_{v} \ddot{u} + {c}_{v} \dot{u} + {k}_{v} u \qquad [ Equation 10 ]$$

f: counteracting force
mᵥ: vehicle mass
cᵥ: vehicle suspension damping coefficient
kᵥ: vehicle suspension spring coefficient
u: height adjusting actuator displacement

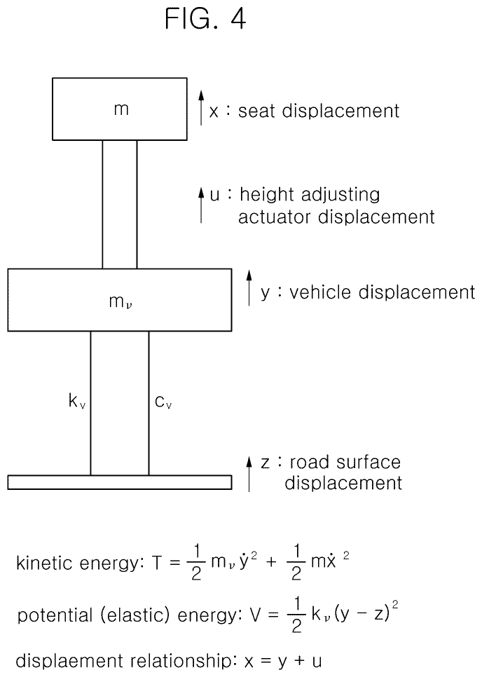

As shown in FIG. 4, the seat according to the present example may be modeled as a configuration in which the vehicle mass mᵥ is supported on a road surface by a suspension damping coefficient cᵥ and a spring coefficient kᵥ, and the seat mass m is supported on the vehicle by the height adjusting actuator 3. The model may be expressed as Equation 11.

$$( {m}_{v} + m ) \ddot{x} + {c}_{v} c \dot{x} + {k}_{v} x = f + d \qquad [ Equation 11 ]$$

where, d is a disturbance expressed as d=cᵥż+kᵥz, and f is a counteracting force expressed as f=mᵥü+cᵥ\dot{u}+kᵥu.

Using Equations 1 and 9, it is possible to obtain the control displacement of the height adjusting actuator 3 to implement the counteracting force.

The vehicle seat vibration suppression device according to the present example may further include a tilt adjusting actuator 13 that may adjust the tilt of the seat 1, and a calibration force determination unit 15 that may determine a calibration force for controlling the tilt adjusting actuator 13 to transform a horizontal component displacement of the seat according to the operation of the height adjusting actuator 3 into a vertical component.

The calibration force determination unit 15 may determine the calibration force by multiplying the counteracting force provided by the counteracting force determination unit 5 by a predetermined calibration gain, for example.

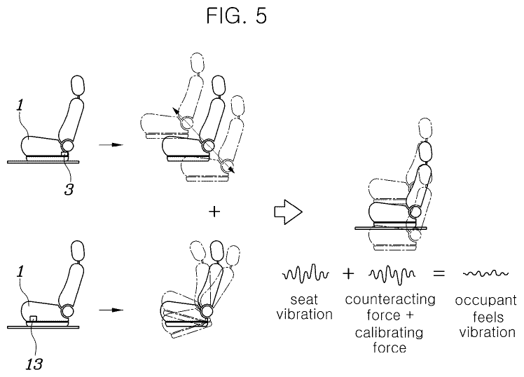

In a case where the active vibration control actuator, provided on the seat 1 of a vehicle to which the present example is applied, includes the height adjusting actuator 3 and the tilt adjusting actuator 13 of the present disclosure, and in a case where the seat 1 is not only moved up and down, but also moved forward and backward (e.g., for various causes such as a structural cause in the operation of the height adjusting actuator 3), and is thus moved in a tilt manner (e.g., as shown in FIG. 5), the height adjusting actuator 3 may be operated to cancel the vibration of the seat and the tilt adjusting actuator 13 may (e.g., simultaneously) be operated to transform the horizontal component displacement generated by the operation of the height adjusting actuator 3. The vehicle forward/backward displacement may be transformed to up/down displacement, to thereby achieve an appropriate seat vibration suppression effect.

The calibration gain may be determined by/based on a number of experiments and/or analyses so that the horizontal component displacement caused by the operation of the height adjusting actuator 3 can be properly transformed to the up/down displacement by multiplying the counteracting force provided to the height adjusting actuator 3 by a specific value of the calibration value.

The seat vibration suppression device according to the present example may further include and/or be configured to communicate with a front sensor 17 provided in the vehicle to detect a road surface in front of the vehicle, and/or a controller 19 that determines the control displacement of the height adjusting actuator 3 through/based on information received from the counteracting force determination unit 5 and the displacement command generator 7 on the basis of unevenness of the front road surface detected by the front sensor 17. The controller may control (e.g., by sending a control signal to) the height adjusting actuator 3 according to the control displacement.

The front sensor 17 may include a camera, or the like. The front sensor 17 may be provided in a front of the vehicle body (e.g., configured to takes a picture and/or video of the road surface on which the vehicle is traveling).

In a case where the seat 1 is provided with the tilt adjusting actuator 13 capable of adjusting the tilt of the seat 1, the controller 19 may control the tilt adjusting actuator 13 according to the calibration force determined by the calibration force determination unit 15.

The controller 19 may implement a continuous control mode and/or an instantaneous control mode (e.g., depending on mode selection, such as via a user interface associated with the controller 19).

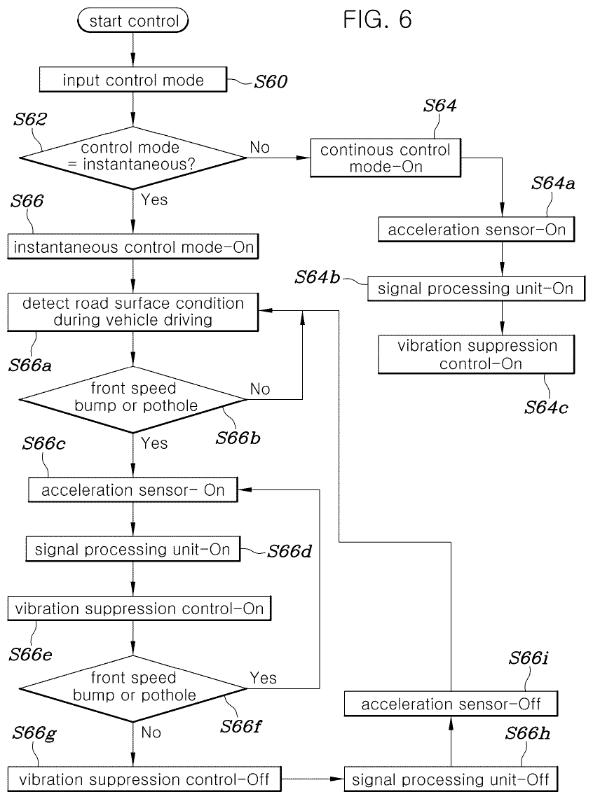

FIG. 6 is a flowchart illustrating a continuous control mode and an instantaneous control mode according to an example of the present disclosure. For convenience, FIG. 6 is described by way of an example in which the steps are performed by a processor circuit. One, some, or all steps of the example method of FIG. 6, or portions thereof, may be performed by one or more other circuits. One or some, steps of the example method of FIG. 6 may be omitted, performed in other orders, and/or otherwise modified, and/or one or more additional steps may be added.

Referring to FIG. 6, a control mode may be input (e.g., via a user interface associated/in communication with the controller 19) (S60). A determination may be made as to whether the input control mode is instantaneous (S62). If the input control mode is not instantaneous (S62—No), for example, if continuous control mode is input (e.g., selected by a driver of the vehicle), the continuous control mode may be turned on (S64). in the continuous control mode, the acceleration sensor 9 may be turned on (S64a) and the signal processing unit 11 may be turned on (S64b), and the seat vibration suppression control may be continuously implemented (S64c).

If the instantaneous control mode is selected/input (S62—Yes), instantaneous control mode may be turned on (S66). In instantaneous control mode, data indicating the road surface condition may be acquired (e.g., a picture may be taken of the road surface in front of the vehicle) by the front sensor 17 to allow detection of road surface condition (e.g., during vehicle driving) (S66a). In particular, the data may be analyzed to determine whether an uneven portion of road that may cause substantial vibrations is going to be driven over (e.g., a front speed bump or pothole) (S66b). Based on determining that there is not substantial unevenness in front of the vehicle warranting vibration suppression (S66b—No), the road surface condition may continue to be detected e.g., data indicating the road surface condition may continue to be acquired (S66a). Based on determining that there is unevenness in the road in front of the vehicle, such as speed bumps or potholes, (S66b-Yes), the acceleration sensor 9 may be turned on (S66c) and the signal processing unit 11 may be turned on (S66d) to perform the vibration suppression control of the seat (S66e). The data indicating the road surface condition may be repeatedly and/or continuously analyzed (S66f). Based on determining that the unevenness is still detected (S66f-Yes), the acceleration sensor 9 may remain on, the signal processing unit 11 may remain on, and vibration suppression control may continue (S66e). Based on determining that there is no unevenness that may cause substantial vibrations in front of the vehicle (e.g., no detected obstacles, such as a front speed bump or pothole) (S66f—No), vibration suppression control may be turned off (S66g), and the acceleration sensor 9 and the signal processing unit 11 may be turned off (S66h-S66i). The data may continue to be acquired to detect road surface conditions (S66a).

As described herein, the unevenness in front of the vehicle refers to obstacles such as speed bumps or potholes that correspond to a level/level change where the seat vibration suppression control is necessary/desired, which may be determined by experiments and analyses, or artificial intelligence. Also, or alternatively, a user of the vehicle may select a level of sensitivity at which the vibration suppression control should be turned on.

For reference, the controller 19 may be provided as a separate component, but may be configured to include one or more of the signal processing unit 11, the counteracting force determination unit 5, the displacement command generator 7, and/or the calibration force determination unit 15. For example, the controller 19 may comprise one or more processors and memory that, when executed by the one or more processors, cause the controller 19 to perform the functions described herein as being performed by one or more of the signal processing unit 11, the counteracting force determination unit 5, the displacement command generator 7, and/or the calibration force determination unit 15. Also, or alternatively, one or more of the signal processing unit 11, the counteracting force determination unit 5, the displacement command generator 7, and/or the calibration force determination unit 15 may be implemented as separate device(s) to the controller 19.

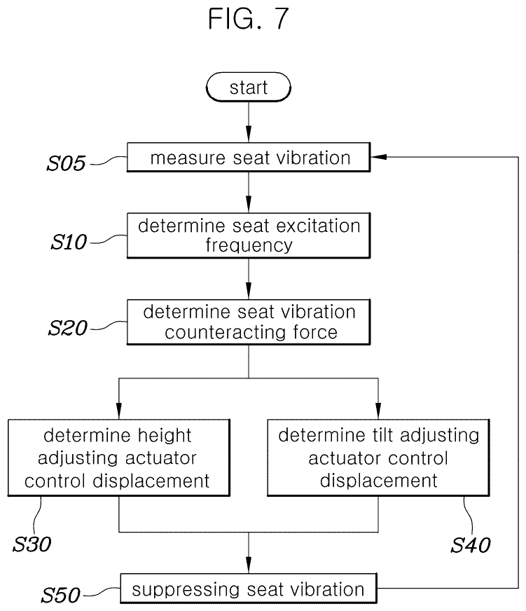

Hereinafter, a vehicle seat vibration suppression method according to an example of the present disclosure will be described. FIG. 7 is a flowchart illustrating an example of a vehicle seat vibration suppression method according to an example of the present disclosure. For convenience, FIG. 7 is described by way of an example in which the steps are performed by a processor circuit. One, some, or all steps of the example method of FIG. 7, or portions thereof, may be performed by one or more other circuits. One or some, steps of the example method of FIG. 7 may be omitted, performed in other orders, and/or otherwise modified, and/or one or more additional steps may be added.

The seat vibration suppression method of the present example may include measuring a seat vibration (S05). Based on the seat vibration, an excitation frequency of the seat may be received/determined (S10). The excitation frequency may be used as an input to determine a counteracting force for suppressing vibration of the seat, by the counteracting force determination unit 5 (S20). A control displacement of the height adjusting actuator 3 for implementing the counteracting force, may be determined by the displacement command generator 7 (S30). A tilt adjusting actuator control displacement may also, or alternatively, be determined (S40). The vibration of the seat may be canceled/controlled by controlling the height adjusting actuator 3 according to the control displacement, by the controller 19 (S50).

The signal processing unit 11 may process a signal output from the acceleration sensor 9 that detects the vibration of the seat to determine the excitation frequency to be input to the counteracting force determination unit 5 (S10).

The signal processing unit 11 may allow, in a case where the frequency of the output signal of the acceleration sensor 9 satisfies (e.g., is less than) a predetermined reference frequency, the output signal of the acceleration sensor 9 to sequentially pass through the moving average filter and the low pass filter, or allows, in a case where the frequency of the output signal of the acceleration sensor 9 does not satisfy (e.g., is equal to or greater than) the reference frequency, the output signal of the acceleration sensor 9 to pass through the band-pass filter to thereby output the excitation frequency.

The counteracting force determination unit 5 may determine the counteracting force according to the following equation.

$$\frac{F ( s )}{\ddot{X} ( s )} = - \frac{{m}_{a} ( 2 {ζ}_{α} {ω}_{α} s + {ω}_{α}^{2} )}{{s}^{2} + 2 {ζ}_{2} {ω}_{α} s + {ω}_{α}^{2}}$$

F(s): counteracting force
\ddot{X}(s): vibration (acceleration) of seat
mₐ: virtual mass of control system for suppressing seat vibration, which is function of vehicle mass, seat mass, and tuning factor
ζ_{α}: damping ratio of control system
ωₐ: excitation frequency of seat
s: Laplace variable

The displacement command generator 7 may determine the control displacement of the height adjusting actuator 3 by multiplying the following equation by the Laplace transform of the counteracting force.

$$\frac{U ( s )}{F ( s )} = \frac{1}{{m}_{v} {s}^{2} + {c}_{v} s + {k}_{v}} = \frac{1}{{m}_{v} ( {s}^{2} + 2 {ζ}_{v} {ω}_{v} s + {ω}_{v}^{2} )}$$

U(s): control displacement of height adjusting actuator 3
F(s): counteracting force
mᵥ: vehicle mass
cᵥ: vehicle suspension damping coefficient
kᵥ: vehicle suspension spring coefficient
ζᵥ: vehicle suspension damping ratio
ωᵥ: vehicle suspension natural frequency

Also, or alternatively, in a case where the tilt adjusting actuator 13 capable of adjusting the tilt of the seat cushion 1 is provided, the calibration force determination unit 15 may determine a calibration force for controlling the tilt adjusting actuator 13 so that a horizontal component displacement of the seat according to the operation of the height adjusting actuator 3 is transformed to an up/down component.

The calibration force determination unit 15 may determine the calibration force by multiplying the counteracting force provided by the counteracting force determination unit 5 by a predetermined calibration gain.

In a case where the vehicle is provided with the front sensor 17 to detect a road surface in front of the vehicle, the controller 19 may determine the control displacement of the height adjusting actuator 3 through the counteracting force determination unit 5 and the displacement command generator 7, on the basis of unevenness of the front road surface detected by the front sensor 17 satisfying a condition to warrant vibration suppression, and may control the height adjusting actuator 3 according to the control displacement.

The tilt adjusting actuator 13 may be controlled according to the calibration force determined by the calibration force determination unit 15.

The present disclosure provides a vehicle seat vibration suppression device and a method therefor, capable of suppressing vibration applied to a vehicle seat using an actuator for implementing an active vibration control function of the seat, thereby improving ride comfort and merchantability of the vehicle.

The aspect of the present disclosure is not limited to the above-mentioned aspect, and other aspects not mentioned may be clearly understood by those skilled in the art from the following description.

In accordance with an aspect of the present disclosure, the above and other objects can be accomplished by the provision of a vehicle seat vibration suppression device including a height adjusting actuator that adjusts the height of a seat, a counteracting force determination unit that receives an excitation frequency of the seat as an input and determines a counteracting force for suppressing vibration of the seat, and a displacement command generator that determines a control displacement of the height adjusting actuator for implementing the counteracting force determined by the counteracting force determination unit and provides the result to the height adjusting actuator.

The vehicle seat vibration suppression device may further include an acceleration sensor configured to detect the vibration of the seat, and a signal processing unit that processes an output signal of the acceleration sensor and outputs the excitation frequency of the seat to be input to the counteracting force determination unit.

The signal processing unit may process the output signal of the acceleration sensor with different filters according to whether the frequency of the output signal of the acceleration sensor is less than, or equal to or greater than a predetermined reference frequency, and outputs the excitation frequency.

The signal processing unit may allow the output signal of the acceleration sensor to sequentially pass through a moving average filter and a low pass filter in a case where the frequency of the output signal of the acceleration sensor is less than the predetermined reference frequency, and may allow the output signal of the acceleration sensor to pass through a band-pass filter in a case where the frequency of the output signal of the acceleration sensor is equal to or greater than the reference frequency, to output the excitation frequency.

The counteracting force determination unit may determine the counteracting force according to the following equation:

$$\frac{F ( s )}{\ddot{X} ( s )} = - \frac{{m}_{a} ( 2 {ζ}_{α} {ω}_{α} s + {ω}_{α}^{2} )}{{s}^{2} + 2 {ζ}_{2} {ω}_{α} s + {ω}_{α}^{2}}$$

where F(s): Laplace transform of counteracting force,
\ddot{X}(s): Laplace transform of vibration (acceleration) of seat,
mₐ: virtual mass of control system for suppressing seat vibration, which is a function of vehicle mass, seat mass, and tuning factor,
ζ_{α}: damping ratio of control system,
ωₐ: excitation frequency of seat, and
s: Laplace variable.

The displacement command generator may determine the control displacement of the height adjusting actuator by multiplying the following equation by the Laplace transform of the counteracting force:

$$\frac{U ( s )}{F ( s )} = \frac{1}{{m}_{v} {s}^{2} + {c}_{v} s + {k}_{v}} = \frac{1}{{m}_{v} ( {s}^{2} + 2 {ζ}_{v} {ω}_{v} s + {ω}_{v}^{s} )}$$

where U(s): Laplace transform for control displacement of height adjusting actuator,
F(s): Laplace transform of counteracting force,
mᵥ: vehicle mass,
cᵥ: vehicle suspension damping coefficient,
kᵥ: vehicle suspension spring coefficient,
ζᵥ: vehicle suspension damping ratio, and
ωᵥ: vehicle suspension natural frequency.

The vehicle seat vibration suppression device may further include a tilt adjusting actuator that adjusts a tilt of the seat, and a calibration force determination unit that determines a calibration force for controlling the tilt adjusting actuator to transform a horizontal component displacement of the seat according to an operation of the height adjusting actuator into a vertical component.

The calibration force determination unit may determine the calibration force by multiplying the counteracting force provided by the counteracting force determination unit by a predetermined calibration gain.

The vehicle seat vibration suppression device may further include a front sensor provided in the vehicle to detect a road surface in front of the vehicle, and a controller that determines the control displacement of the height adjusting actuator through the counteracting force determination unit and the displacement command generator on the basis of unevenness of the front road surface detected by the front sensor, which requires measures, and controls the height adjusting actuator according to the control displacement.

The controller may control the tilt adjusting actuator according to the calibration force determined by the calibration force determination unit.

In accordance with another aspect of the present disclosure, there is provided a vehicle seat vibration suppression method including receiving an excitation frequency of a seat as an input and determining a counteracting force for suppressing vibration of the seat, by a counteracting force determination unit, determining a control displacement of a height adjusting actuator for implementing the counteracting force, by a displacement command generator, and suppressing the vibration of the seat by controlling the height adjusting actuator according to the control displacement, by a controller.

The method may further include processing a signal output from an acceleration sensor that detects the vibration of the seat and determining an excitation frequency to be input to the counteracting force determination unit, by a signal processing unit.

The signal processing unit may allow the output signal of the acceleration sensor to sequentially pass through a moving average filter and a low pass filter in a case where the frequency of the output signal of the acceleration sensor is less than a predetermined reference frequency, and may allow the output signal of the acceleration sensor to pass through a band-pass filter in a case where the frequency of the output signal of the acceleration sensor is equal to or greater than the reference frequency, to output the excitation frequency.

The counteracting force determination unit may determine the counteracting force according to the following equation:

$$\frac{F ( s )}{\ddot{X} ( s )} = - \frac{{m}_{a} ( 2 {ζ}_{α} {ω}_{α} s + {ω}_{α}^{2} )}{{s}^{2} + 2 {ζ}_{2} {ω}_{α} s + {ω}_{α}^{2}}$$

where F(s): Laplace transform of counteracting force,
\ddot{X}(s): Laplace transform of vibration (acceleration) of seat,
mₐ: virtual mass of control system for suppressing seat vibration, which is a function of vehicle mass, seat mass, and tuning factor,
ζ_{α}: damping ratio of control system,
ωₐ: excitation frequency of seat, and
s: Laplace variable.

The displacement command generator may determine the control displacement of the height adjusting actuator by multiplying the following equation by the Laplace transform of the counteracting force:

$$\frac{U ( s )}{F ( s )} = \frac{1}{{m}_{v} {s}^{2} + {c}_{v} s + {k}_{v}} = \frac{1}{{m}_{v} ( {s}^{2} + 2 {ζ}_{v} {ω}_{v} s + {ω}_{v}^{2} )}$$

where U(s): Laplace transform for control displacement of height adjusting actuator,
F(s): Laplace transform of counteracting force,
mᵥ: vehicle mass,
cᵥ: vehicle suspension damping coefficient,
kᵥ: vehicle suspension spring coefficient,
ζᵥ: vehicle suspension damping ratio, and
ωᵥ: vehicle suspension natural frequency.

The method may further include determining, in a case where a tilt adjusting actuator for adjusting a tilt of the seat is provided, a calibration force for controlling the tilt adjusting actuator to transform a horizontal component displacement of the seat according to the operation of the height adjusting actuator into a vertical component, by a calibration force determination unit.

The calibration force determination unit may determine the calibration force by multiplying the counteracting force provided by the counteracting force determination unit by a predetermined calibration gain.

The controller may determine, in a case where a front sensor is provided in the vehicle to detect a road surface in front of the vehicle, the control displacement of the height adjusting actuator through the counteracting force determination unit and the displacement command generator on the basis of unevenness of the front road surface detected by the front sensor, which requires measures, and may control the height adjusting actuator according to the control displacement.

The controller may control the tilt adjusting actuator according to the calibration force determined by the calibration force determination unit.

As is apparent from the above description, the present disclosure provides a vehicle seat vibration suppression device capable of suppressing vibration generated on a vehicle seat using an actuator for implementing an active vibration control function of the seat, thereby improving ride comfort and merchantability of the vehicle.

The effects of the present disclosure are not limited to the above-mentioned effects, and other effects not mentioned may be clearly understood by those skilled in the art from the above description.

Although the preferred examples of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A vehicle seat vibration suppression device comprising:
a height adjusting actuator configured to adjust a height of a seat of a vehicle;
a controller circuit configured to:
receive, from a filter of a plurality of filters of a signal processor, an excitation frequency of the seat; and
determine, based on the excitation frequency, a counteracting force for suppressing vibration of the seat; and
a displacement command generator configured to:
determine, based on the counteracting force, a control displacement of the height adjusting actuator for implementing the counteracting force; and
provide the control displacement to the height adjusting actuator to cause the height adjusting actuator to adjust the height of the seat of the vehicle.

2. The device according to claim 1, further comprising:
an acceleration sensor configured to detect the vibration of the seat; and
the signal processor configured to:
process an output signal of the acceleration sensor configured to measure vibration of the seat; and
output the excitation frequency of the seat to the controller circuit.

3. The device according to claim 2, wherein the signal processor is configured to:
process the output signal of the acceleration sensor by filtering the output signal with a filter, of the plurality of filters, based on whether a frequency of the output signal of the acceleration sensor is less than a predetermined reference frequency; and
output the excitation frequency.

4. The device according to claim 3, wherein the signal processor is configured to output the excitation frequency by either:
based on a frequency of the output signal of the acceleration sensor being less than the predetermined reference frequency, sequentially passing the output signal through a moving average filter and a low pass filter of the plurality of filters; or
based on the frequency of the output signal being equal to or greater than the predetermined reference frequency, passing the output signal through a band-pass filter of the plurality of filters.

5. The device according to claim 1, wherein the controller circuit is further configured to determine the counteracting force according to the following equation:
$$\frac{F ( s )}{\ddot{X} ( s )} = - \frac{{m}_{α} ( 2 {ζ}_{α} {ω}_{α} s + {ω}_{α}^{2} )}{{s}^{2} + 2 {ζ}_{α} {ω}_{α} s + {ω}_{α}^{2}}$$
where F(s): Laplace transform of counteracting force,
\ddot{X}(s): Laplace transform of vibration (acceleration) of seat,
mₐ: virtual mass of control system for suppressing seat vibration, which is a function of vehicle mass, seat mass, and tuning factor,
ζ_{α}: damping ratio of control system,
ωₐ: excitation frequency of seat, and
s: Laplace variable.

6. The device according to claim 5, wherein the displacement command generator is configured to determine the control displacement of the height adjusting actuator by multiplying the following equation by the Laplace transform of the counteracting force:
$$\frac{U ( s )}{F ( s )} = \frac{1}{{m}_{v} {s}^{2} + {c}_{v} s + {k}_{v}} = \frac{1}{{m}_{v} ( {s}^{2} + 2 {ξ}_{v} {ω}_{v} s + {w}_{v}^{2} )}$$
where U(s): Laplace transform for control displacement of height adjusting actuator,
F(s): Laplace transform of counteracting force,
mᵥ: vehicle mass,
cᵥ: vehicle suspension damping coefficient,
kᵥ: vehicle suspension spring coefficient,
ζᵥ: vehicle suspension damping ratio, and
ωᵥ: vehicle suspension natural frequency.

7. The device according to claim 1, further comprising:
a tilt adjusting actuator configured to adjust a tilt of the seat, wherein the controller circuit is further configured to determine a calibration force for controlling the tilt adjusting actuator to transform a horizontal component displacement of the seat according to an operation of the height adjusting actuator into a vertical component.

8. The device according to claim 7, wherein the controller circuit is further configured to determine the calibration force by multiplying the counteracting force by a predetermined calibration gain.

9. The device according to claim 8, further comprising:
a front sensor, of the vehicle, configured to detect a surface of a road in front of the vehicle,
wherein the controller circuit is configured to:
determine, based on detected unevenness of the road and the displacement command generator, the control displacement of the height adjusting actuator; and
control, based on the control displacement, the height adjusting actuator.

10. The device according to claim 9, wherein the controller circuit is configured to control, based on the determined calibration force, the tilt adjusting actuator.

11. A vehicle seat vibration suppression method comprising:
receiving, by a controller circuit and from a signal processor, an excitation frequency of a seat of a vehicle;
determining, based on the excitation frequency, a counteracting force for suppressing vibration of the seat;
determining, based on the counteracting force and via a displacement command generator, a control displacement of a height adjusting actuator of the seat; and
controlling, based on the control displacement, the height adjusting actuator to adjust a height of the seat to implement the counteracting force.

12. The method according to claim 11, wherein the receiving of the excitation frequency comprises:
receiving, from the signal processor, a filtered signal by filtering an output signal output from an acceleration sensor configured to detect vibration of the seat; and
determining, based on the filtered signal, the excitation frequency.

13. The method according to claim 12, wherein the filtered signal is filtered by:
a moving average filter; and
either:
based on a frequency of the output signal being less than a predetermined reference frequency, a low pass filter; or
based on the frequency of the output signal being equal to or greater than the predetermined reference frequency, a band-pass filter.

14. The method according to claim 11, wherein the determining of the counteracting force comprises determining the counteracting force according to the following equation:
$$\frac{F ( s )}{\ddot{X} ( s )} = - \frac{{m}_{α} ( 2 {ζ}_{α} {ω}_{α} s + {ω}_{α}^{2} )}{{s}^{2} + 2 {ζ}_{2} {ω}_{α} s + {ω}_{α}^{2}}$$
where F(s): Laplace transform of counteracting force,
\ddot{X}(s): Laplace transform of vibration (acceleration) of seat,
mₐ: virtual mass of control system for suppressing seat vibration, which is a function of vehicle mass, seat mass, and tuning factor,
ζ_{α}: damping ratio of control system,
ωₐ: excitation frequency of seat, and
s: Laplace variable.

15. The method according to claim 14, wherein the determining of the control displacement of the height adjusting actuator comprises multiplying the following equation by the Laplace transform of the counteracting force:
$$\frac{U ( s )}{F ( s )} = \frac{1}{{m}_{v} {s}^{2} + {c}_{v} s + {k}_{v}} = \frac{1}{{m}_{v} ( {s}^{2} + 2 {ξ}_{v} {ω}_{v} s + {w}_{v}^{2} )}$$
where U(s): Laplace transform for control displacement of height adjusting actuator,
F(s): Laplace transform of counteracting force,
mᵥ: vehicle mass,
cᵥ: vehicle suspension damping coefficient,
kᵥ: vehicle suspension spring coefficient,
ζᵥ: vehicle suspension damping ratio, and
ωᵥ: vehicle suspension natural frequency.

16. The method according to claim 14, further comprising:
determining, based on a tilt adjusting actuator for adjusting a tilt of the seat, a calibration force for controlling the tilt adjusting actuator to transform a horizontal component displacement of the seat into a vertical component displacement of the seat.

17. The method according to claim 16, wherein the determining of the calibration force comprises multiplying the counteracting force by a predetermined calibration gain.

18. The method according to claim 17, wherein the determining of the control displacement of the height adjusting actuator is further based on an unevenness of a front road surface detected by a front sensor of the vehicle.

19. The method according to claim 18, further comprising controlling, based on the calibration force, the tilt adjusting actuator.

20. The method of claim 11, wherein the controlling, based on the control displacement, of the height adjusting actuator is performed continuously.
